(19) United States
(12) Patent Application Publication
(10) Pub. No.: US 2024/0410062 A1
(43) Pub. Date: Dec. 12, 2024

(54) METHODS AND SYSTEMS FOR HIGH-EFFICIENCY AND HIGH-RATE GREEN HYDROGEN PRODUCTION FROM SALT WATER USING SEDIMENTARY ROCK ELECTRODE

(71) Applicant: The American University in Cairo, Cairo (EG)

(72) Inventor: Moustafa ElSayed Oraby, New Cairo (EG)

(21) Appl. No.: 18/805,171

(22) Filed: Aug. 14, 2024

Related U.S. Application Data
(63) Continuation of application No. 18/220,100, filed on Jul. 10, 2023.
(60) Provisional application No. 63/532,515, filed on Aug. 14, 2023.
(60) Provisional application No. 63/359,605, filed on Jul. 8, 2022.

(51) Int. Cl. C25B 1/04; C25B 11/02; C25B 11/067; C25B 11/089

(52) U.S. Cl. CPC C25B 1/04; C25B 11/02; C25B 11/067; C25B 11/089

(57) ABSTRACT

A method for producing hydrogen gas through electrolysis of a salt water solution using an electrode with a sedimentary rock portion includes placing a first electrode comprising a metallic material in a salt water solution and positioning the first electrode in a tower. The method further includes placing a second electrode comprising a metallic material portion and a sedimentary rock portion into the salt water solution. The method further includes allowing the salt water solution to permeate at least a portion of the sedimentary rock portion. The method further includes connecting a direct current (DC) power supply to the first and second electrodes. The method further includes applying, using the power supply, a DC voltage between the first and second electrodes, thereby causing electrolysis of at least a portion of the salt water solution and producing hydrogen gas in the tower.

### PRIORITY CLAIM

This application claims the priority benefit of U.S. Provisional Patent Application Ser. No. 63/532,515, filed Aug. 14, 2023. This application is also a continuation-in-part of U.S. patent application Ser. No. 18/220,100, filed Jul. 10, 2023, which claims the priority benefit of U.S. Provisional Patent Application Ser. No. 63/359,605, filed Jul. 8, 2022. The disclosures of each of the applications referenced in this paragraph are incorporated herein by reference in their entireties.

### TECHNICAL FIELD

The subject matter described herein relates to hydrogen gas production with high efficiency, high rate and biproducts. More particularly, the subject matter described herein relates to methods and systems for electrolysis of salt water using an electrode with a sedimentary rock portion and collection of the hydrogen using a tower isolated from atmospheric pressure that includes an opening that allows salt water in the tower to be displaced by the hydrogen gas as the hydrogen gas is produced.

### BACKGROUND

Hydrogen gas can be produced by placing electrodes in salt water and applying a direct current (DC) voltage to electrodes immersed in the salt water. Conventionally, the electrodes used for electrolysis are metallic electrodes. Using metallic electrodes results in corrosion of the electrodes and can also result in excessive chlorine production.

Accordingly, there exists a need for electrolysis of a salt water solution that avoids at least some of these difficulties.

### SUMMARY

A method for producing hydrogen gas through electrolysis of a salt water solution using an electrode with a sedimentary rock portion includes placing a first electrode comprising a metallic material in a salt water solution, the first electrode being positioned in a tower. The method further includes placing a second electrode comprising a metallic material portion and a sedimentary rock portion into the salt water solution. The method further includes allowing the salt water solution to permeate the sedimentary rock portion. The method further includes connecting a direct current (DC) power supply to the first and second electrodes. The method further includes applying, using the DC power supply, a DC voltage between the first and second electrodes, thereby causing electrolysis of at least a portion of the salt water solution and producing hydrogen gas in the tower.

In an aspect of the subject matter described herein, the method includes controlling the applied DC voltage to control an efficiency and/or rate of hydrogen gas production.

In an aspect of the subject matter described herein, the method includes collecting sodium hypochlorite produced from the electrolysis.

In an aspect of the subject matter described herein, the method includes adding an acid to the salt water solution after causing electrolysis, thereby converting sodium hypochlorite produced from the electrolysis to at least chlorite.

In an aspect of the subject matter described herein, the method includes isolating the tower from atmospheric pressure after positioning the first electrode in the tower.

In an aspect of the subject matter described herein, the tower is made from a non-conductive material.

In an aspect of the subject matter described herein, the salt water solution comprises a sea water solution.

In an aspect of the subject matter described herein, the salt water solution has a concentration of sodium chloride of about 35 thousand parts per million.

In an aspect of the subject matter described herein, the first electrode comprises a negative electrode and the second electrode comprises a positive electrode.

In an aspect of the subject matter described herein, the tower includes an opening to allow the salt water to be displaced from the tower as the hydrogen gas is produced in the tower.

In an aspect of the subject matter described herein, the sedimentary rock portion comprises at least one of sandstone, limestone, and dolomite.

In an aspect of the subject matter described herein, the sedimentary rock portion comprises a porosity in a range of about 29.5% to about 32%.

In an aspect of the subject matter described herein, the sedimentary rock portion comprises a permeability in a range of about 40 millidarcy (md) to about 660 md.

In an aspect of the subject matter described herein, the sedimentary rock portion comprises a hollow interior region.

In an aspect of the subject matter described herein, the metallic portion comprises a band that at least partially surrounds the sedimentary rock portion.

A system for producing hydrogen gas through electrolysis of a salt water solution using an electrode with a sedimentary rock portion includes a first metallic electrode and a second electrode comprising a metallic material portion and a sedimentary rock portion. The system further includes a container for holding the first and second electrodes and at least partially submerging the first and second electrodes in a salt water solution. The container includes a tower configured to collect hydrogen gas. The system further includes a direct current (DC) power supply for connecting to the first and second electrodes and applying a DC voltage to the first and second electrodes when the electrodes are at least partially submerged in the salt water solution, thereby causing electrolysis of at least a portion of the salt water solution and producing hydrogen gas.

In an aspect of the subject matter described herein, the container comprises a first chamber for holding the first electrode in the salt water solution, a second chamber for holding the second electrode in the salt water solution and an aperture for allowing the salt water solution to flow between the first and second chambers.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary implementations of the subject matter described herein will now be explained with reference to the accompanying drawings, of which:

FIG. 1 is a schematic diagram of a system for producing hydrogen gas through electrolysis of salt water using an electrode with a sedimentary rock portion;

FIG. 2 is an image of an example laboratory setup for electrolysis of salt water using an electrode with a sedimentary rock portion;

FIG. 3 is an image of an example electrode with a sedimentary rock portion;

FIG. 4 is an image of a DC power supply showing voltage and current settings for an example laboratory setup for a high efficiency rate in hydrogen production;

FIG. 5 is an image of the tower filled with salt water in the example laboratory setup of FIG. 4;

FIG. 6 is an image displaying a measured current in the example laboratory setup of FIG. 4;

FIG. 7 is an image of hydrogen gas produced in the example laboratory setup of FIG. 4;

FIG. 8 is an image of the hydrogen gas volume by water displacement after ten hours of operating the example experiment of FIG. 4;

FIG. 9 is an image of the water condition after ten hours of operating the example experiment of FIG. 4;

FIG. 10 is an image of the DC power supply showing image and current setting for an example laboratory setup;

FIG. 11 is an image of the tower filled with salt water in the example laboratory setup of FIG. 10;

FIG. 12 is an image displaying a measured current in the example laboratory setup of FIG. 10;

FIG. 13 is an image of hydrogen gas produced in the example laboratory setup of FIG. 10;

FIG. 14 is an image of the hydrogen gas volume by water displacement after nine hours of operating the example experiment of FIG. 10;

FIG. 15 is an image of the water condition after nine hours of operating the example experiment of FIG. 10;

FIG. 16 is an image of the DC power supply showing voltage and current settings for an example laboratory setup;

FIG. 17 is an image of the tower filled with salt water in the example laboratory setup of FIG. 16;

FIG. 18 is an image displaying a measured current in the example laboratory setup of FIG. 16;

FIG. 19 is an image of hydrogen gas produced in the example laboratory setup of FIG. 16;

FIG. 20 is an image of the hydrogen gas volume by water displacement after 7.5 hours of operating the example experiment of FIG. 16;

FIG. 21 is an image of the water condition after 7.5 hours of operating the example experiment of FIG. 16 showing some indication of chlorinated water;

FIG. 22 is an image of the DC power supply showing voltage and current settings for an example laboratory setup;

FIG. 23 is an image of the hydrogen gas volume after twenty minutes of operating the example experiment of FIG. 22;

FIG. 24 is an image of the hydrogen gas volume by water displacement after forty minutes of operating the example experiment of FIG. 22;

FIG. 25 is an image of the hydrogen gas volume by water displacement after forty minutes of operating the example experiment of FIG. 22;

FIG. 26 is an image of the water condition after forty minutes of operating the example experiment of FIG. 22;

FIG. 27 is an image of the DC power supply showing voltage and current settings for an example laboratory setup;

FIG. 28 is an image of the laboratory setup of FIG. 27 soon after commencing the experiment;

FIG. 29 is an image of the water condition after operating the example experiment of FIG. 27 with the byproduct sodium hypochlorite;

FIG. 30 is an image of the water condition after adding citric acid in the example experiment of FIG. 27; and

FIG. 31 is a flow chart of an example method for producing hydrogen gas through electrolysis of salt water using an electrode with a sedimentary rock portion.

### DETAILED DESCRIPTION

The subject matter described herein includes a design of a positive electrode in the electrolysis operations of extracting green hydrogen gas from salt water, including, but not limited to sea water, enabling the positive electrode to resist the corrosion process. The subject matter described herein also enables continuous, uninterrupted, and a high rate of hydrogen production with no limits on the applied power during the electrolysis operation. The operation is uninterrupted because of reduced corrosion of the electrodes during electrolysis and reduced deposits of metal oxides in the water over conventional methods using only metallic electrodes. Rather than being deposited in the water between the electrodes, chlorine remains largely in the voids of the sedimentary rock electrode. An example advantage to producing hydrogen gas from salt water is that an endless supply of ocean water is readily available. Another benefit to using salt water in electrolysis is that it produces desirable biproducts, namely sodium hypochlorite or chlorine.

### Exemplary Methodology

The Earth's crust was formed millions of years ago through accumulation of sediments and grains, called sedimentary rock. The three major sedimentary rocks in nature known to Earth scientists are sandstone, limestone, and dolomite. All sediments have two properties, porosity and permeability, that differentiate one sediment from the other. Porosity is the percentage of voids in the sedimentary rock with respect to its total volume. These voids are filled with water. Permeability is the measure of the easiness of the fluids inside the rock to move between the rock pores. The sediments that are on the surface of the Earth have high porosity and high permeability due to the low pressure, which is called overburden pressure by Earth scientists, exerted on the rock.

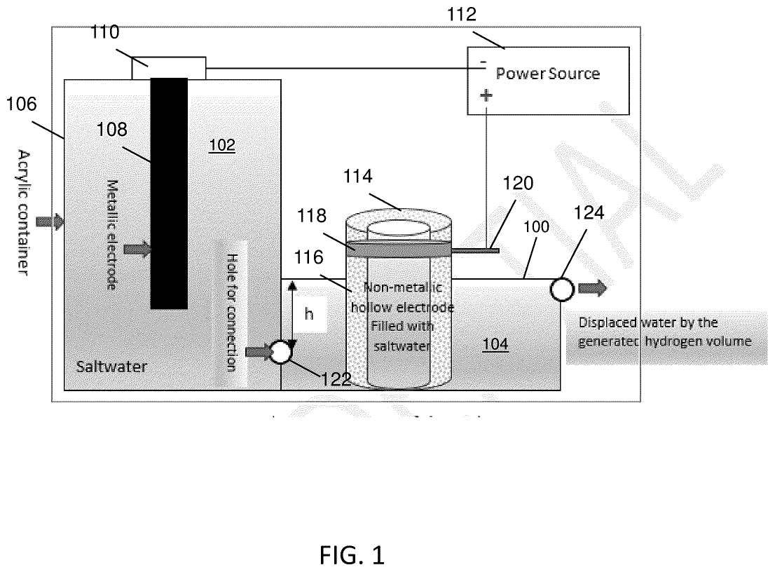

FIG. 1 shows a schematic diagram of an example system for electrolysis of salt water using an electrode with a sedimentary rock portion. In FIG. 1, the system includes a container 100 configured to hold salt water. The salt water may include ocean water or any other type of water that includes a dissolved salt. Container 100 may include a negative electrode chamber 102 and a positive electrode chamber 104. Negative electrode chamber 102 may be made from an electrically non-conductive material, for example, acrylic. Negative electrode chamber 102 is formed by a tower 106 that is configured to collect hydrogen gas produced from electrolysis when an electrical current is applied to the salt water. A metallic negative electrode 108 can be removably inserted in tower 106. Negative electrode 108 can be attached to a lid 110 that removably attaches to tower 106, which, when attached, seals an opening in the top of tower 106 and isolates chamber 102, namely the inside of tower 106, from atmospheric pressure. A negative terminal of a DC power source 112 may be electrically connected to negative electrode 108. When DC power is applied, positive hydrogen and sodium ions produced from the electrolysis collect at negative electrode 108.

Positive electrode chamber 104 may similarly be made from an electrically non-conductive material, for example, acrylic. A positive electrode 114 is located in positive electrode chamber 104. Positive electrode 114 includes a non-metallic sedimentary rock portion 116 contacting a metallic portion 118. Metallic portion 118 may form a ring or collar around an outer surface of non-metallic sedimentary rock portion 116 and a metallic junction 120 to connect to DC power source 112 to pull a positive current. The current flows from metallic junction 120 through the porous formation rock to the water inside of sedimentary rock portion 116 closing the electric circuit. Sedimentary rock portion 116, in the illustrated example, includes a cylinder of sedimentary rock surrounding a hollow core.

While FIG. 1 illustrates a sedimentary rock electrode having a hollow cylindrical geometry, other geometries can be used without departing from the scope of the subject matter described herein. For example, in an alternate implementation, non-metallic sedimentary rock portion 116 may comprise any geometric shape with a hollow interior cavity, such as a cylinder, prism, triangular prism, rectangular prism, a space-filled polyhedron, an irregular shape, and the like and each of which may include a hollow interior cavity. Other examples of sedimentary rock portions that may be suitable for electrode 114 are described in above-referenced U.S. patent application Ser. No. 18/220,100.

Examples of porosity and permeability measurements for surface plugs (i.e., sedimentary rock plugs obtained from rocks on the surface of the Earth's crust) that may be used as material to form sedimentary rock portion 116 are shown in Table 1. The measurements show that almost 30% of the volume is porous, while 70% is rock grains. Also, the permeability can reach up to 600-700 millidarcy, indicating easiness of fluid movements across the plug. When the plugs are saturated with high saline water, the electrical resistance of the plug is very low.

TABLE 1
Porosity and permeability of some core samples from the Earth's surface

| | | Sample | Sample | Bulk | | Grain | Pore | Grain | Core | |
|---|---|---|---|---|---|---|---|---|---|---|
| Sample | Sample | dia. | Length | Vol. | Weight | Vol | Vol. | dens. | Porosity | Perm. |
| No | ID | (mm) | (mm) | (cc) | (g) | (cc) | (cc) | (g/cc) | (%) | (md) |
| 1 | A1 | 25.40 | 68.19 | 34.55 | 63.47 | 23.72 | 10.83 | 2.68 | 31.35% | 657.681 |
| 2 | A2 | 25.38 | 68.06 | 34.43 | 63.78 | 24.01 | 10.42 | 2.66 | 30.26% | 584.575 |
| 3 | A3 | 25.38 | 67.28 | 34.04 | 63.29 | 23.63 | 10.41 | 2.68 | 30.58% | 620.219 |
| 4 | A4 | 25.50 | 67.61 | 34.53 | 64.08 | 23.99 | 10.54 | 2.67 | 30.52% | 445.657 |
| 5 | A5 | 25.43 | 67.78 | 34.43 | 63.74 | 23.71 | 10.72 | 2.69 | 31.14% | 535.422 |
| 6 | B1 | 25.50 | 71.26 | 36.39 | 67.11 | 24.84 | 11.55 | 2.70 | 31.74% | 235.784 |
| 7 | B2 | 25.44 | 71.52 | 36.35 | 66.85 | 24.70 | 11.65 | 2.71 | 32.05% | 220.742 |
| 8 | B3 | 25.46 | 71.34 | 36.32 | 67.26 | 24.72 | 11.60 | 2.72 | 31.94% | 224.831 |
| 9 | B4 | 25.38 | 71.44 | 36.14 | 67.21 | 24.75 | 11.39 | 2.72 | 31.52% | 193.957 |
| 10 | B5 | 25.40 | 71.61 | 36.29 | 67.63 | 25.00 | 11.29 | 2.71 | 31.11% | 250.621 |
| 11 | C1 | 25.44 | 71.85 | 36.52 | 68.49 | 25.10 | 11.42 | 2.73 | 31.27% | 165.651 |
| 12 | C2 | 25.38 | 71.91 | 36.38 | 68.70 | 25.36 | 11.02 | 2.71 | 30.29% | 185.406 |
| 13 | C3 | 25.40 | 71.34 | 36.15 | 67.79 | 24.99 | 11.16 | 2.71 | 30.87% | 168.81 |
| 14 | C4 | 25.40 | 71.45 | 36.20 | 68.37 | 25.12 | 11.08 | 2.72 | 30.61% | 186.688 |
| 15 | C5 | 25.40 | 71.70 | 36.33 | 68.35 | 25.10 | 11.23 | 2.72 | 30.91% | 208.358 |
| 16 | D1 | 25.40 | 68.60 | 34.76 | 65.51 | 24.49 | 10.27 | 2.67 | 29.55% | 71.432 |
| 17 | D2 | 25.38 | 69.70 | 35.26 | 66.00 | 24.63 | 10.63 | 2.68 | 30.15% | 125.1065 |
| 18 | D4 | 25.35 | 69.32 | 34.99 | 65.75 | 24.47 | 10.52 | 2.69 | 30.07% | 60.898 |
| 19 | D5 | 25.40 | 69.88 | 35.41 | 65.75 | 24.96 | 10.45 | 2.63 | 29.51% | 44.846 |

Non-metallic sedimentary rock portion 116 may have a porosity and permeability within ranges that include, but are not limited to the porosity and permeability values in Table 1. For example, in Table 1, the porosities range from about 29.5% to about 32% and the permeabilities range from about 40 millidarcy (md) to about 660 md. However, porosities and permeabilities in ranges outside of those exemplified by Table 1 can be used without departing from the scope of the subject matter described herein.

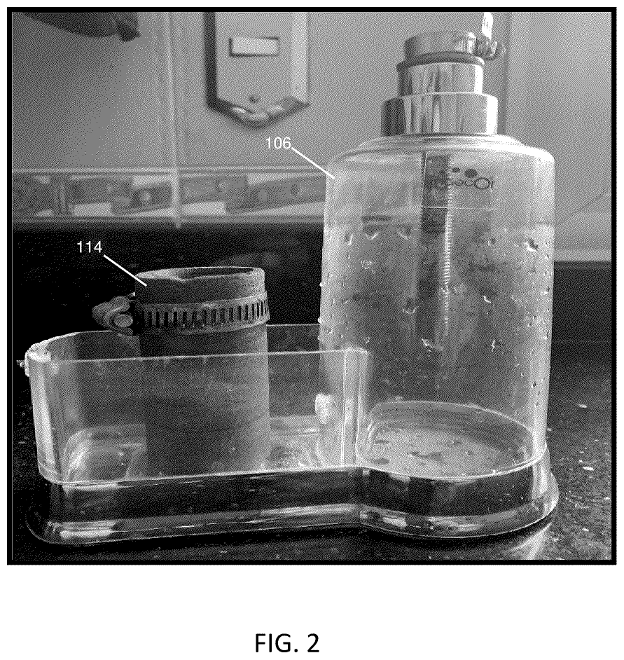

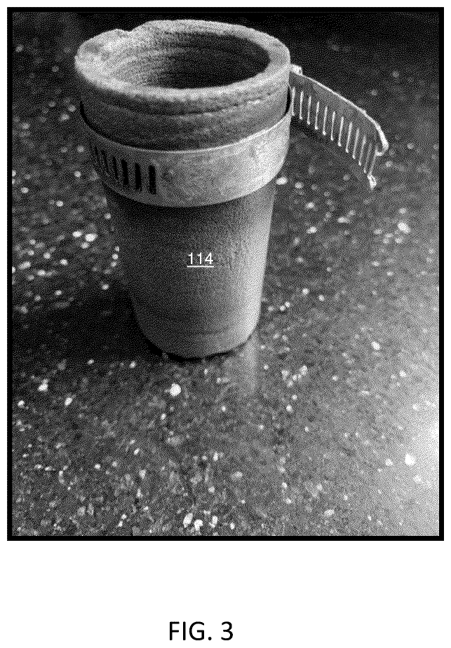

Negative electrode chamber 102 and positive electrode chamber 104 are connected through a closeable opening 122, also referred to herein as a junction, through which the salt water may flow when opening 122 is not closed. When chambers 102 and 104 are being filled with salt water, opening 122 between the chambers is closed. Non-metallic sedimentary rock portion 116 is positioned to be at least partially submerged in the salt water, while metallic portion 118 of positive electrode 114 remains above the water line to avoid corrosion during electrolysis. Negative electrode 108 is then firmly screwed in place on the top of tower 106 to isolate chamber 102 from the atmospheric pressure, while chamber 104 is left open to atmospheric pressure. At the time of the electrolysis process, junction or opening 122 between the two chambers is opened to allow the current to flow. As the electrolysis produces hydrogen gas, the hydrogen gas collects around negative electrode 108 in tower 106, displacing the water in the tower 106 through opening 122 between chambers 102 and 104. The displaced water may be released from positive electrode chamber 104 through an opening 124 in positive electrode chamber 104, or the water may simply flow over a top edge of positive electrode chamber 104. Measuring the displaced water from the electrolysis is an indirect way to measure the volume of produced hydrogen gas. The pressure inside negative electrode chamber 102 formed or enclosed by tower 106, at junction or opening 122, can be calculated as

$${P}_{at junction} = {P}_{atm} + h ρ g$$

where (h) is the distance from opening 122 to the rim of non-metallic electrode chamber 104, (ρ) is the salt water density, Pₐₜₘ is atmospheric pressure where container 100 is located, and (g) is the gravitational acceleration constant. FIG. 2 shows hydrogen tower 106 used in the laboratory while FIG. 3 shows the hollow non-metallic sedimentary rock cylinder used as positive electrode 114 in the measurements described herein. As described herein with the various laboratory setups, the applied DC voltage can be adjusted to control an efficiency and/or rate of hydrogen gas production. For example, a minimum applied voltage to perform the electrolysis, which is approximately 1.23 V, may be used to approach 100% efficiency of hydrogen gas production at the expense of a low production rate. Alternatively, the applied voltage may be increased to increase the production rate of hydrogen gas at the expense of efficiency, measured as the ratio of the energy of the produced hydrogen (which is directly proportional to the volume of hydrogen gas produced) to the electrical energy used in the electrolysis.

### The Electrolysis Process

The electrolysis process of saltwater, including seawater, is based on decomposing both the water, H₂O, and the dissolved salt, NaCl, to their ionic components.

For water

H₂O---->H₂⁺+½O₂⁻

For salt

NaCl---->Na⁺+½Cl₂⁻

Both the hydrogen and the sodium ions diffuse to the negative electrode while the oxygen and chlorine ions diffuse to the positive electrode. Sodium, Na⁺, is very reactive, and once sodium is generated, it reacts with the water creating sodium hydroxide, called caustic soda, as follows:

Na⁺+H₂O----->NaOH+½H₂

The sodium hydroxide will then react with the chlorine and generate sodium hypochlorite, NaOCl, as follows:

NaOH+Cl₂----->NaOCl+NaCl+H₂O

### The Biproducts

The following byproducts may be produced when performing electrolysis of salt water using the system illustrated in FIG. 1.

### 1. Sodium Hypochlorite

Sodium hypochlorite is the main ingredient of bleaching and water disinfection products.

### 2. Chlorine Gas

If the water in the non-metallic electrode chamber is doped with citric acid or hydrochloric acid, HCl, the reaction will break down the sodium hypochlorite and chlorine gas will be generated and dissolves in the water.

### Experimental Work

The experimental work described herein was performed in the laboratory to cover multiple applications for salt water electrolysis as follows:
1. Generating green hydrogen with the highest possible, or pre-planned, efficiency without interest in the biproducts
2. Generating green hydrogen at a high rate without observing the operational efficiency and without interest in the biproducts
3. Generating green hydrogen at a high rate and high efficiency without interest in the biproducts
4. Generating green hydrogen with interest in biproducts

### First: Green Hydrogen with Efficiency

The definition of the efficiency varies between scientists interested in green hydrogen production. The definitions are based on the methodology of generating the green hydrogen, especially when using membranes like alkaline membrane method. In the examples described herein, there are no membranes used in the operation, and hence the simplest and the direct efficiency definition is used. The efficiency is defined as

$$Efficiency ( η ) = \frac{E nergy generated from the Produced Hydrogen}{E nergy used in the Electrolysis}$$

The denominator, the energy used in the electrolysis, can be calculated using the DC power source voltage, current and the operating time as

$$Energy used in the Electrolysis = V * I * t$$

where:
V=The applied volt in the electrolysis operation in Volts
I=The dragged current in Amperes
t=The operation time in hours
   The required voltage to decompose the water into its elemental components, hydrogen and oxygen, using the electrolysis process depends on the thermodynamic energy of the water molecule, called the Gibbs free energy. The Gibbs free energy can be calculated at any temperature and pressure as

$$E = {E}^{0} - \frac{R T}{n F} ln \frac{[ {H}_{2} O ]}{{[ {H}_{2} ] [ {O}_{2} ]}^{1 / 2}}$$

where:
E=The thermodynamic voltage under prevailing conditions
E⁰=The thermodynamic voltage under standard conditions
R=The gas constant (8.314 J degree K⁻¹ mole⁻¹)
T=Temperature in degrees Kelvin (25° C.=298 K)
n=The number of electrons transferred (2 in the case of water)
F=Faraday constant (96,485 Coulombs per mole)
[ ]=Notation that refers to the thermodynamic activity of the reactants and products, which, for gases, can be approximated by their partial pressure in atmospheres.
   The Gibbs free energy can then be converted into voltage using the formula,

$$Gibbs free energy ( standard conditions ) = n * F * {E}^{0}$$

in which free energy is in joules per mole.
Under standard conditions, the Gibbs free energy for the hydrogen-oxygen reaction is 237.2 KJ/mole at 25° C. Therefore, the thermodynamic voltage for a hydrogen-oxygen fuel cell operating at standard temperature and pressure is 1.229 volts, usually approximated as 1.23 Volts, calculated using the above equation as follows:

$${E}^{0} = \frac{237 , 200 J}{2 * ( 96485 )} = 1.229 Volts$$

The numerator, Energy Generated from the Produced Hydrogen, can be calculated from the produced hydrogen using Coulomb's law. Below are the steps to calculate the energy produced from 1 Kg of liquid hydrogen (The volume of 1 Kg of Hydrogen=11.2 cubic meters)
Hydrogen molecule is composed of two atoms H₂
Hydrogen mole=2.016 grams
one kilogram of hydrogen=469.0317 moles
Number of atoms in a mole=Avogadro's number=6.0221408*10²³atoms
Number of electrons in 1 Kg of Hydrogen=469.0317*6.0221408*10²³*2=5.65*10²⁶
1 electron has a charge=1.60217663*10⁻¹⁹ Coulombs
Electric charge in I Kg of Hydrogen=5.65*10²⁶*1.60217663*10⁻¹⁹=90,522,979.595 Coulombs
1 coulomb=1.0 Ampere/sec=0.00027778 Ampere/Hr
1 Kg of hydrogen generates=90,522,979.595*0.00027778=25,145.272 Ampere/Hr
1 Kg of hydrogen has energy=25,145.272 K watt/Hr
1 Horsepower=745.699 Watts
1 Kg of hydrogen generates=33.7 horsepower/Hour
Hydrogen density @ 25° C. and 1.0 atmospheric pressure=0.0813 g/cc

### 1. The Experimental Work for Efficiency

To examine the hydrogen production efficiency of the system including the hydrogen tower and a non-metallic positive electrode, multiple experiments are performed with different input power. The input power varied based on the applied voltage, the dragged current and the operating time as

$$Power = Volt * Current * Time$$

The experimental setup for all cases is the one shown in FIGS. 2 and 3. When the hydrogen is generated, the hydrogen travels up in chamber 102 due to its low density and results in displacing the water from chamber 102 through opening 122 and into chamber 104. The displaced water is then collected and is used to measure the hydrogen volume. The produced hydrogen volume per watt.hr is calculated as follows:

$$Hydrogen Volume per watt . h r = \frac{Total Hydrogen Volume}{V * I * time}$$

The hydrogen volume based on Gibbs function at 100% efficiency is calculated as

$$Hydrogen Volume per watt . hr based on Gibbs = \frac{Total Hydrogen Volume}{V * I * time} = 332 cc per watt . hr$$

The efficiency is then calculated as

$$Efficiency ( η ) = \frac{p r o duced hydrogen volume per watt . hr}{332}$$

### 1.1 The First Experiment

The first experiment is run at the minimum voltage required by Gibbs function, 1.2 V. The water condition after the electrolysis shows no signs of any corrosion as expected using the non-metallic electrode. Also, the water in chamber 104 is doped with citric acid to stop the production of the sodium hypochlorite. The addition of citric acid converts sodium hypochlorite to sodium and chlorine. The detail of the setup is as follows:
Voltage=1.2 Volts
Dragged Current=0.014 Amperes
Operating Time=10 Hours
Hydrogen gas volume generated=55 cc

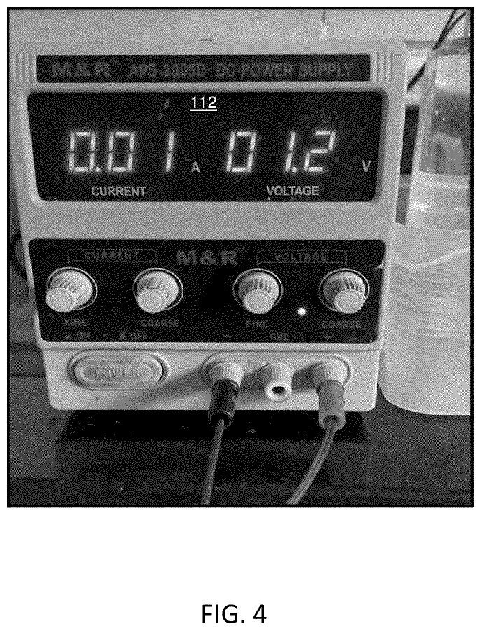

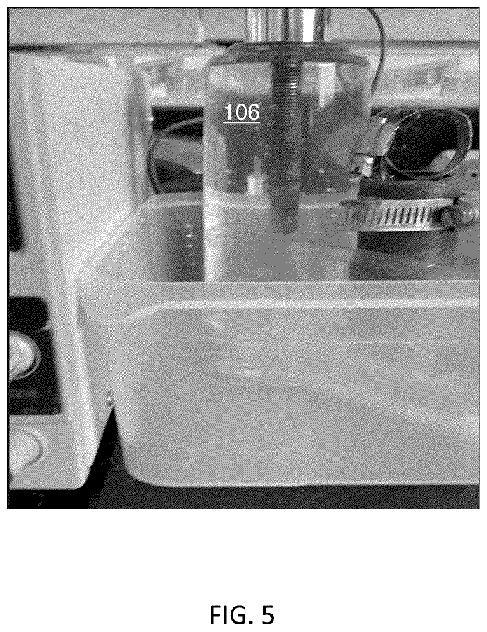

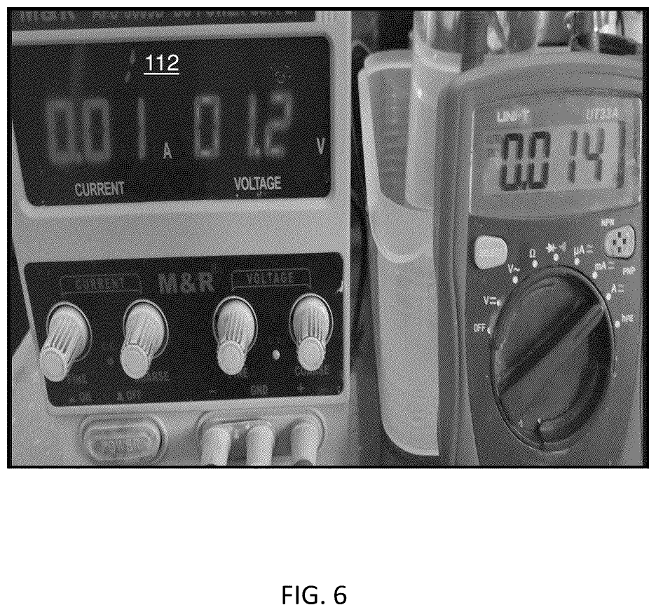

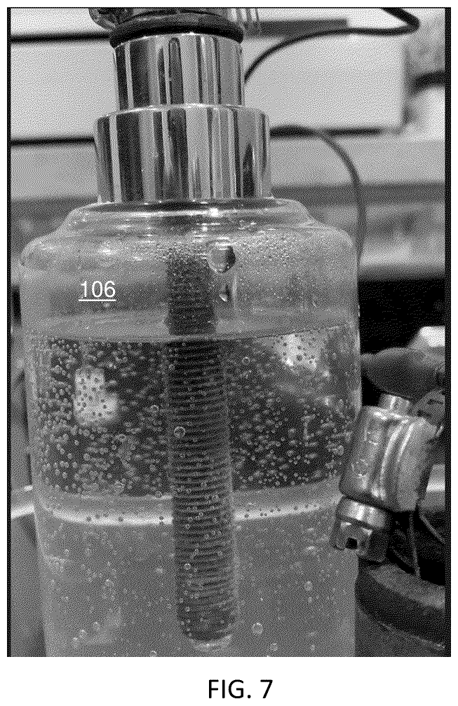

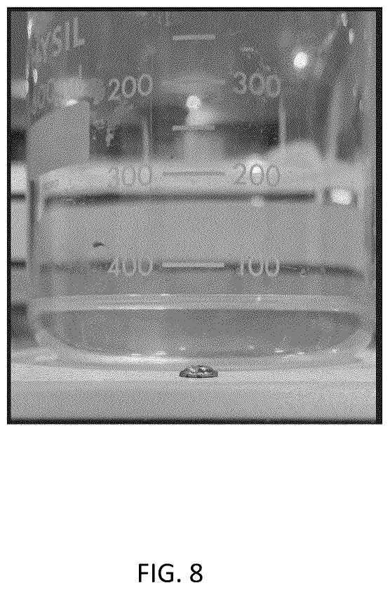

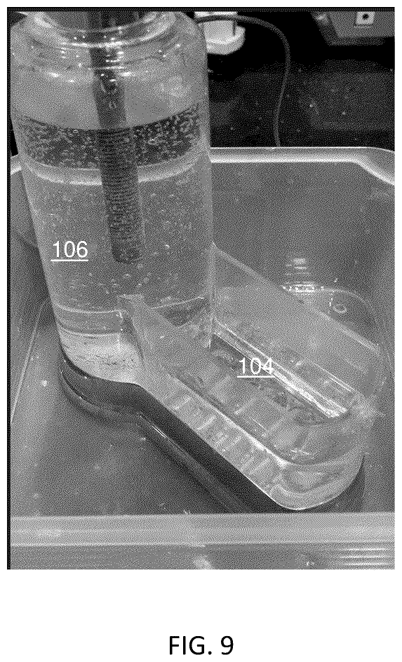

FIG. 4 is an image of DC power supply 112 showing voltage and current settings for an example laboratory setup for a high efficiency rate in hydrogen production. FIG. 5 is an image of tower 106 filled with salt water in the example laboratory setup of FIG. 4. FIG. 6 is an image displaying a measured current in the example laboratory setup of FIG. 4. FIG. 7 is an image of hydrogen gas produced in the example laboratory setup of FIG. 4. FIG. 8 is an image of the hydrogen gas volume by water displacement after ten hours of operating the example experiment of FIG. 4. FIG. 9 is an image of the water condition after ten hours of operating the example experiment of FIG. 4.

### The Efficiency Calculations

$$Produced hydrogen gas per watt . hr = \frac{55}{1.2 * 0.014 * 10} = 327 cc per watt . hr$$

$$Efficiency ( η ) = \frac{produced hydrogen volume per watt . hr}{332}$$

$$Efficiency ( η ) = \frac{327}{332} = 98.6 \%$$

### 1.2 The Second Experiment

The second experiment is run at 1.8 V. The water condition after the operation shows no signs of any corrosion as expected using the non-metallic electrode. Also, the water in chamber 104 is doped with citric acid to stop the production of the sodium hypochlorite. The detail of the setup is as follows:
Voltage=1.8 Volts
Dragged Current=0.023 Amperes
Operating Time=9 Hours
Hydrogen gas volume generated=85 cc

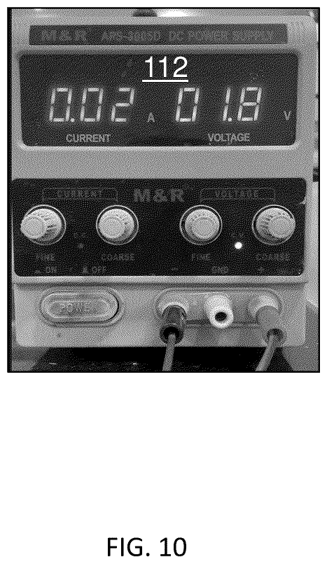

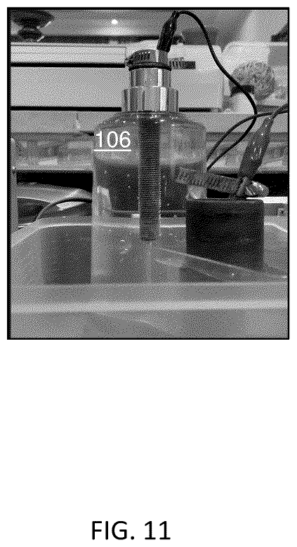

FIG. 10 is an image of DC power supply 112 showing voltage and current settings for an example laboratory setup. FIG. 11 is an image of tower 106 filled with salt water in the example laboratory setup of FIG. 10.

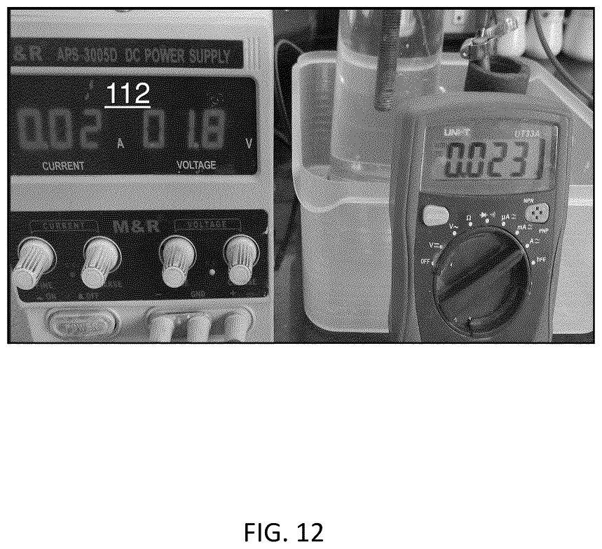

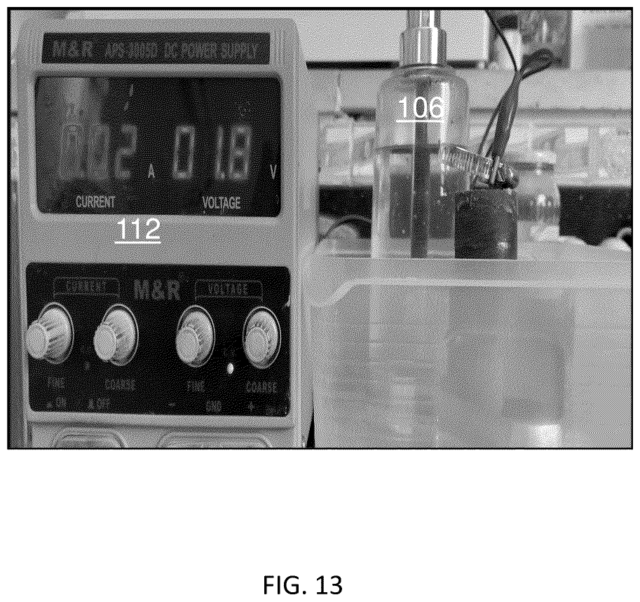

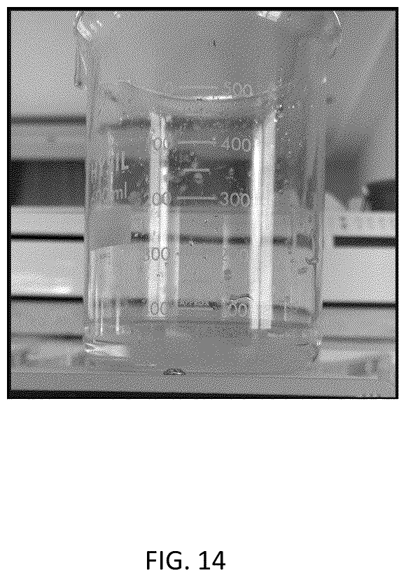

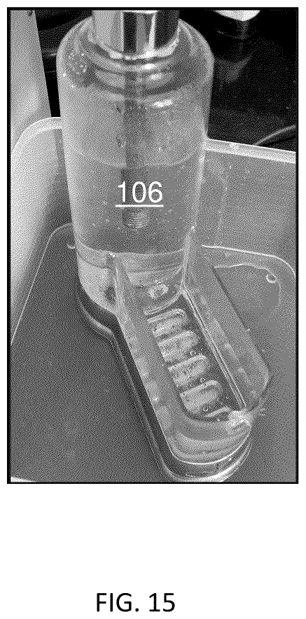

FIG. 12 is an image displaying a measured current in the example laboratory setup of FIG. 10. FIG. 13 is an image of hydrogen gas produced in the example laboratory setup of FIG. 10. FIG. 14 is an image of the hydrogen gas volume by water displacement after nine hours of operating the example experiment of FIG. 10. FIG. 15 is an image of the water condition after nine hours of operating the example experiment of FIG. 10.

### Efficiency Calculations

$$Produced hydrogen gas per watt . hr = \frac{85}{1.8 * 0.023 * 9} = 228 cc per watt . hr$$

$$Efficiency ( η ) = \frac{produced hydrogen volume per watt . hr}{332}$$

$$Efficiency ( η ) = \frac{228}{332} = 68.6 \%$$

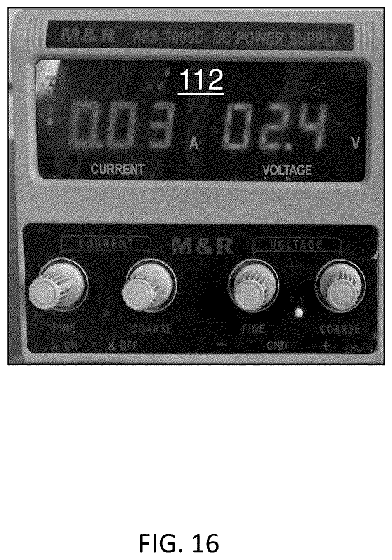

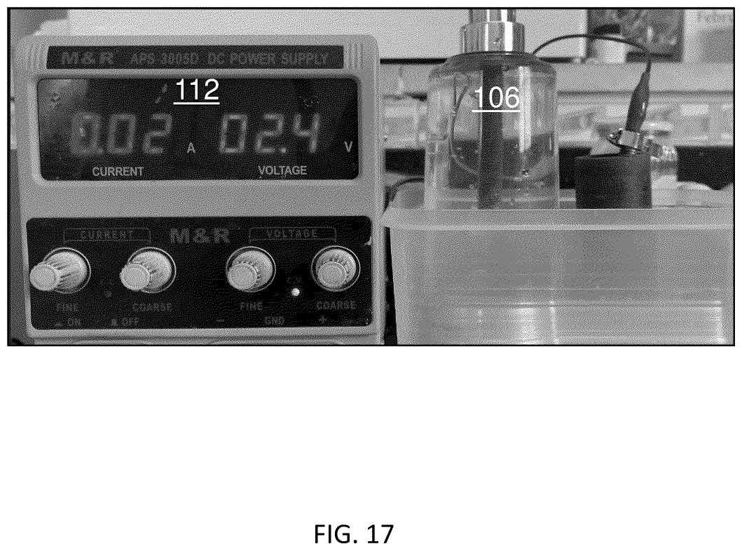

FIG. 16 is an image of DC power supply 112 showing voltage and current settings for an example laboratory setup. FIG. 17 is an image of tower 106 filled with salt water in the example laboratory setup of FIG. 16.

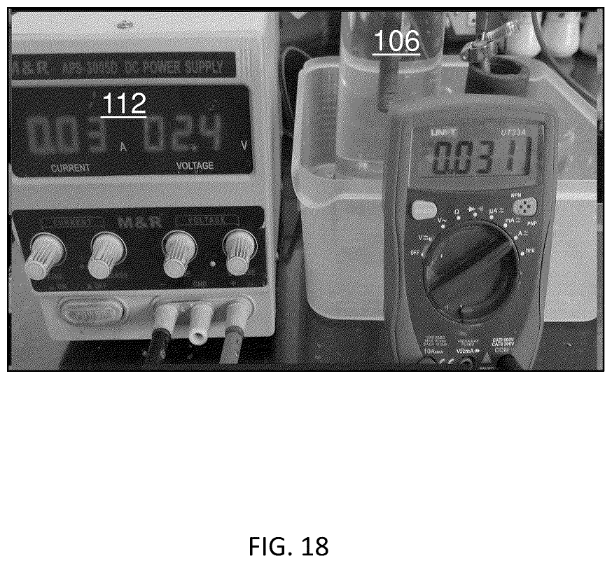

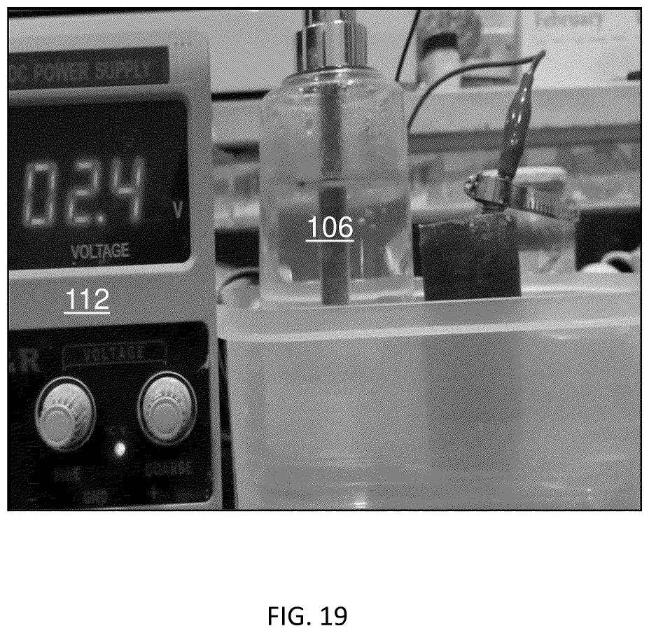

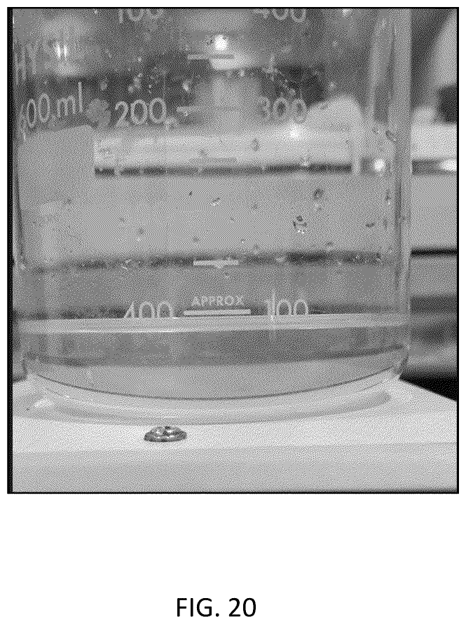

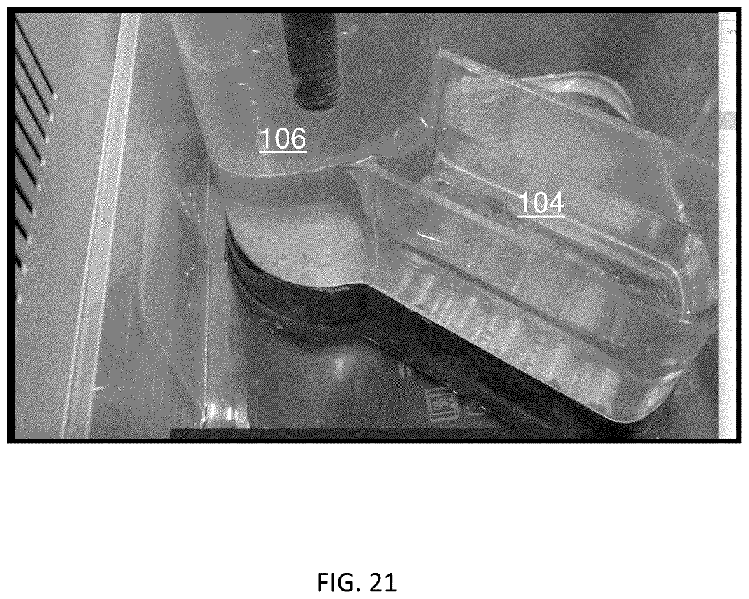

FIG. 18 is an image displaying a measured current in the example laboratory setup of FIG. 16. FIG. 19 is an image of hydrogen gas produced in the example laboratory setup of FIG. 16. FIG. 20 is an image of the hydrogen gas volume by water displacement after 7.5 hours of operating the example experiment of FIG. 16. FIG. 21 is an image of the water condition after 7.5 hours of operating the example experiment of FIG. 16 showing some indication of chlorinated water.

### Efficiency Calculations

$$Produced hydrogen gas per watt . hr = \frac{90}{2.4 * 0.031 * 7.5} = 161 cc per watt . hr$$

$$Efficiency ( η ) = \frac{produced hydrogen volume per watt . hr}{332}$$

$$Efficiency ( η ) = \frac{161}{332} = 48.5 \%$$

### 2. The Experimental Work for High Rate—No interest in Biproducts

In many cases, a high hydrogen gas production rate is required without concerns of the operational efficiency. This case is considered when the input energy does not provide a cost burden on the green hydrogen production operation. An example of this is when the input power is generated using the solar panels. In this case, the cost of the input power is very limited and is considered only as a capital cost in the form of the solar panels. The capital cost of the panels will be quickly recovered from the produced green hydrogen. This option is considered in countries where the sun covers the entire year for long time, e.g., Middle East countries, the North African continent, and the Mid-African continent.

### 2.1 The Experimental Setup

The experiment is run at the maximum voltage available from the DC power generator in the laboratory. The DC power generator is used here only for the experimental work in the laboratory, but, in practice, the DC power generator may be replaced by power from solar panels. The water condition shows no signs of any corrosion as expected using the non-metallic electrode. Also, the water in the second chamber is doped with citric acid to stop the production of the sodium hypochlorite and it clearly showed the chlorine gas which is dissolved in the water in this chamber. The hydrogen volume generated in this experiment was 150 CC in only forty minutes. The detail of the setup is as follows:
Voltage=32.4 Volts
Dragged Current=0.43 Amperes
Operating Time=40 minutes
Hydrogen gas volume generated=150 cc
   The above data shows that the production is very high compared to the production from the previous sets of experiments when the efficiency is observed.

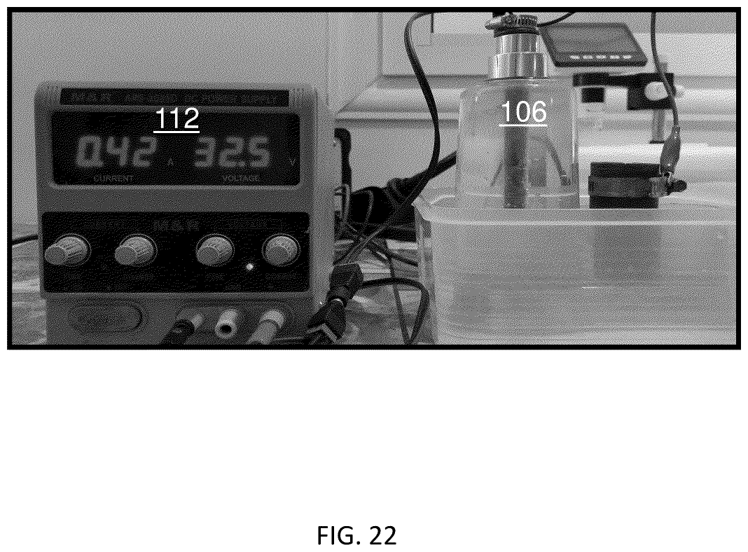

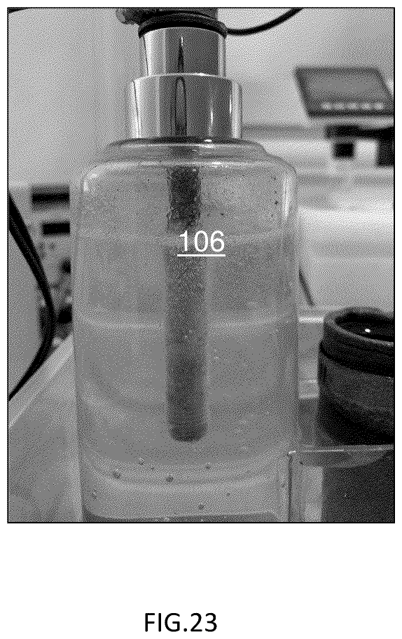

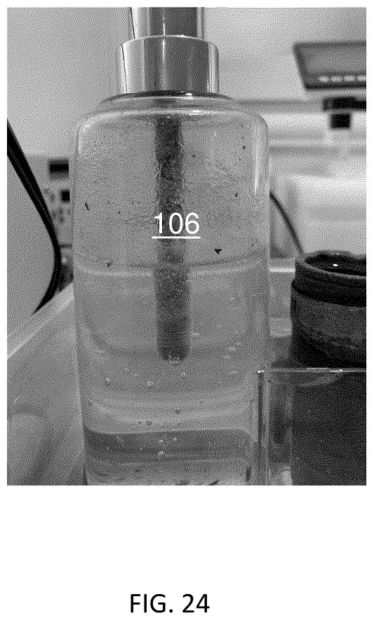

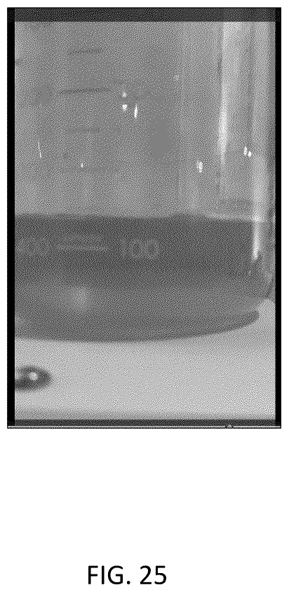

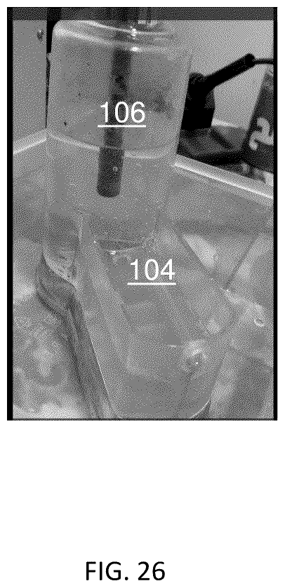

FIG. 22 is an image of DC power supply 112 showing voltage and current settings for an example laboratory setup. FIG. 23 is an image of the hydrogen gas volume after twenty minutes of operating the example experiment of FIG. 22. FIG. 24 is an image of the hydrogen gas volume by water displacement after forty minutes of operating the example experiment of FIG. 22. FIG. 25 is an image of the hydrogen gas volume by water displacement after forty minutes of operating the example experiment of FIG. 22. FIG. 26 is an image of the water condition after forty minutes of operating the example experiment of FIG. 22.

### The Efficiency Calculations

$$Produced hydrogen gas per watt . hr = \frac{150}{32.4 * 0.43 * ( \frac{40}{60} )} = 16.15 cc per watt . hr$$

$$Efficiency ( η ) = \frac{produced hydrogen volume per watt . hr}{332}$$

$$Efficiency ( η ) = \frac{16.15}{332} = 4.86 \%$$

As expected, the efficiency of the high-rate electrolysis process is very low, but the volume of hydrogen produced per hour is very high. It is also important to note that most of the input power in this type of high-rate hydrogen production will be dissipating in the electrolysis process and will result in elevating the water temperature.

### 3. The Experimental Work with Interest in Biproducts

When the biproducts are of interest to the user of the green hydrogen production, the only difference from the previous-described setups for efficient and high-rate hydrogen production is that the salt water in chamber 104 will not be doped with any acids. This will allow the biproducts to form in chamber 104.

### The Experimental Setup

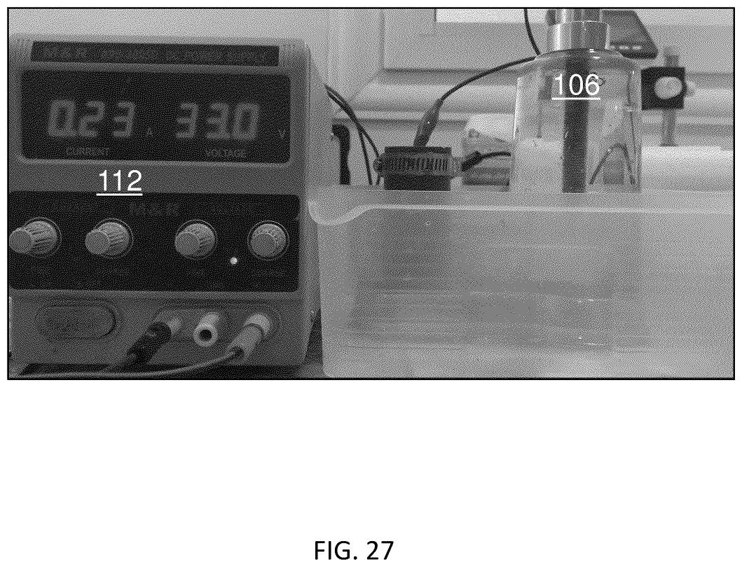

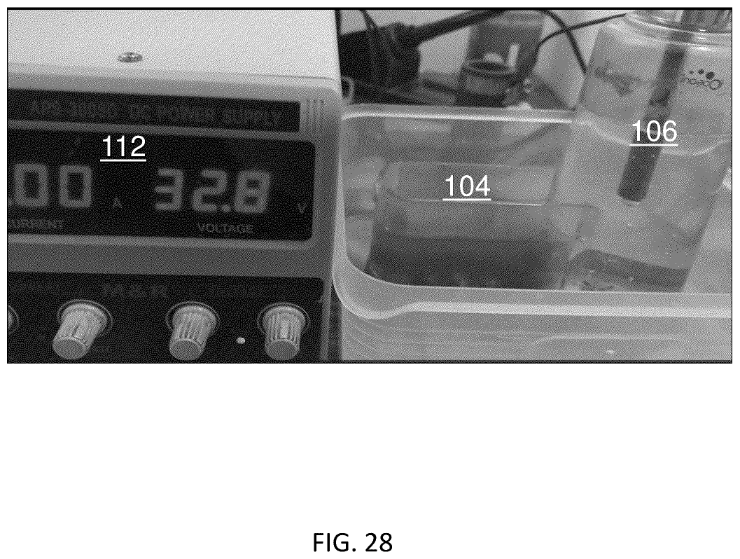

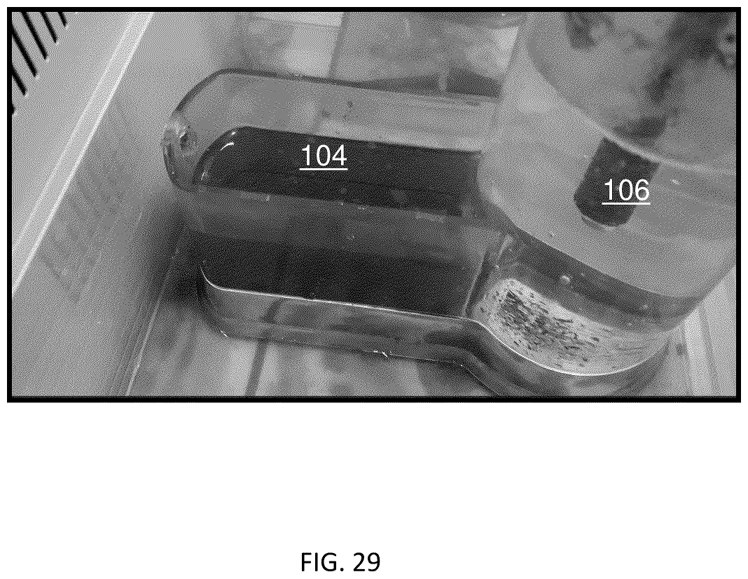

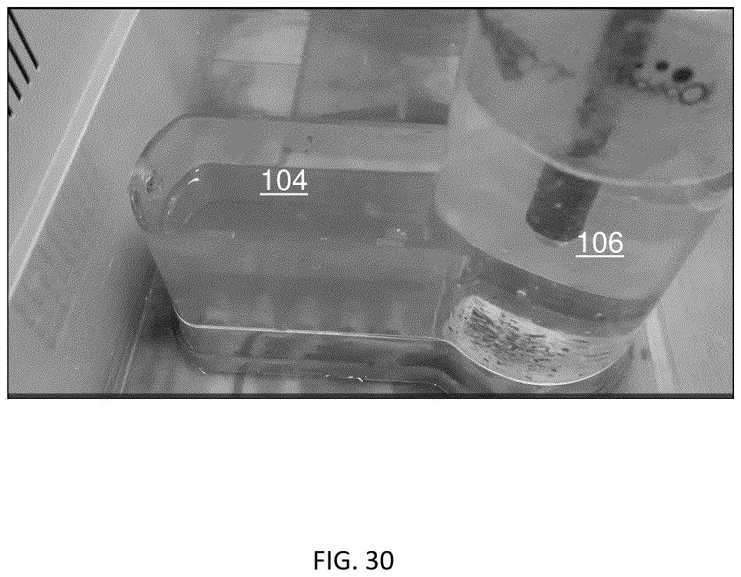

The experiment is run at the maximum voltage available from the DC power generator in the laboratory like the setup of the high rate. The water in chamber 104 is pure salt water without any added acids. FIG. 27 is an image of DC power supply 112 showing voltage and current settings for an example laboratory setup with interest in biproducts produced. FIG. 28 is an image of the laboratory setup of FIG. 27 soon after commencing the experiment. FIG. 29 is an image of the water condition after operating the example experiment. The color of the liquid in chamber 104 has changed to a greenish hue, indicating the development of the sodium hypochlorite. If the required biproduct is the chlorine, then the water in the chamber 104 will be mixed with the citric acid after the operation. The acid will break down the sodium hypochlorite, and chlorine will be generated. FIG. 30 is an image of the water condition after adding citric acid in the example experiment of FIG. 27.

### The Experimental Work for High Rate and High Efficiency—No interest in Biproducts

When a high rate of high-efficiency hydrogen production is required, required then the setup of the high efficiency discussed earlier should be downsized, with a small tower structure, and hydrogen production should be repeated multiple times to obtain the desired hourly rate. This approach is the adopted approach in the industry when a high production rate and high efficiency are both required. This setup faces a high capital cost.

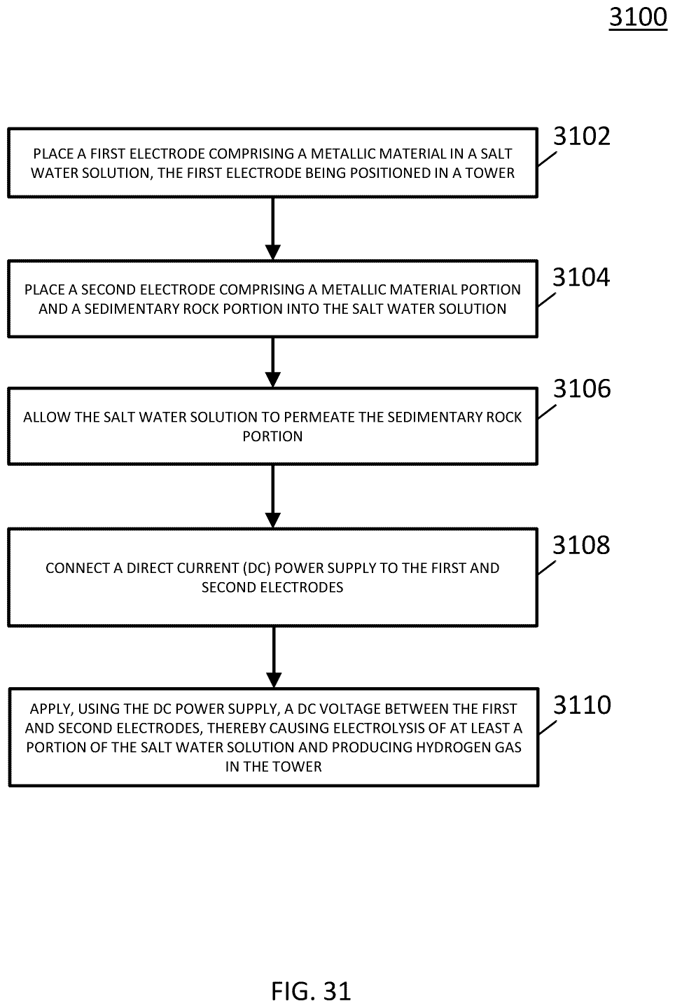

FIG. 31 is a flow chart illustrating an example method 3100 for producing hydrogen gas through electrolysis of salt water using an electrode with a sedimentary rock portion. At step 3102, a first electrode comprising a metallic material is placed in a salt water solution, the first electrode positioned in a tower. The tower may be made of a non-conductive material. The first electrode can include a negative electrode.

At step 3104, a second electrode including a metallic material portion and a sedimentary rock portion is placed into the salt water solution. The tower can be isolated from atmospheric pressure after positioning the first electrode in the tower. The salt water solution can include a sea water solution. The sea water solution can have a concentration of sodium chloride of about 35 thousand parts per million. The second electrode can include a positive electrode. The sedimentary rock portion can include at least one of sandstone, limestone, and dolomite. The sedimentary rock portion can include a porosity in a range of about 29.5% to about 32%. The sedimentary rock portion can include a permeability in a range of about 40 millidarcy (md) to about 660 md. The sedimentary rock portion can include a hollow interior region. The metallic portion can include a band that at least partially surrounds the sedimentary rock portion.

At step 3106, the salt water solution is allowed to permeate the sedimentary rock portion.

At step 3108, a direct current (DC) power supply is connected to the first and second electrodes.

At step 3110, using the DC power supply, a DC voltage is applied between the first and second electrodes, thereby causing electrolysis of at least a portion of the salt water solution and producing hydrogen gas in the tower. The applied DC voltage can be controlled to control an efficiency and/or rate of hydrogen gas production. Sodium hypochlorite produced from the electrolysis can be collected. An acid can be added to the salt water solution after causing electrolysis, thereby converting sodium hypochlorite produced from the electrolysis into at least chlorite.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for producing hydrogen gas through electrolysis of a salt water solution using an electrode with a sedimentary rock portion, the method comprising:
placing a first electrode comprising a metallic material in a salt water solution, the first electrode being positioned in a tower;
placing a second electrode comprising a metallic material portion and a sedimentary rock portion into the salt water solution;
allowing the salt water solution to permeate the sedimentary rock portion;
connecting a direct current (DC) power supply to the first and second electrodes; and
applying, using the DC power supply, a DC voltage between the first and second electrodes, thereby causing electrolysis of at least a portion of the salt water solution, producing hydrogen gas in the tower.

2. The method of claim 1 comprising controlling the applied DC voltage to control an efficiency and/or a rate of hydrogen gas production.

3. The method of claim 1 comprising collecting sodium hypochlorite produced from the electrolysis.

4. The method of claim 1 comprising adding an acid to the salt water solution after causing the electrolysis, thereby converting sodium hypochlorite produced from the electrolysis into at least chlorite.

5. The method of claim 1 wherein a chamber formed by the tower is isolated from atmospheric pressure.

6. The method of claim 1 wherein the tower is made from a non-conductive material.

7. The method of claim 1 wherein the salt water solution comprises a sea water solution.

8. The method of claim 7 wherein the sea water solution has a concentration of sodium chloride of about 35 thousand parts per million.

9. The method of claim 1 wherein the first electrode comprises a negative electrode and the second electrode comprises a positive electrode.

10. The method of claim 1 wherein the tower includes an opening to allow the salt water to be displaced from the tower as the hydrogen gas is produced in the tower.

11. The method of claim 1 wherein the sedimentary rock portion comprises at least one of sandstone, limestone, and dolomite.

12. The method of claim 1 wherein the sedimentary rock portion comprises a porosity in a range of about 29.5% to about 32%.

13. The method of claim 1 wherein the sedimentary rock portion comprises a permeability in a range of about 40 millidarcy (md) to about 660 md.

14. The method of claim 1 wherein the sedimentary rock portion comprises a hollow interior region.

15. The method of claim 1 wherein the metallic portion comprises a band that at least partially surrounds the sedimentary rock portion.

16. A system for producing hydrogen gas through electrolysis of a salt water solution using an electrode with a sedimentary rock portion, the system comprising:
a first metallic electrode;
a second electrode comprising a metallic material portion and a sedimentary rock portion;
a container for holding the first and second electrodes and at least partially submerging the first and second electrodes in a salt water solution;
the container including a tower configured to collect hydrogen gas; and
a direct current (DC) power supply for connecting to the first and second electrodes and applying a DC voltage to the first and second electrodes when the electrodes are at least partially submerged in the salt water solution, thereby causing electrolysis of at least a portion of the salt water solution and producing hydrogen gas in the tower.

17. The system of claim 16 wherein the container comprises a first chamber for holding the first electrode in the salt water solution, a second chamber for holding the second electrode in the salt water solution and an opening for allowing the salt water solution to flow between the first and second chambers as the hydrogen gas is produced in the tower and displaces the salt water in the tower.

18. The system of claim 16 wherein the sedimentary rock portion comprises at least one of sandstone, limestone, and dolomite.

19. The system of claim 16 wherein the sedimentary rock portion comprises a porosity in a range of about 29.5% to about 32%.

20. The system of claim 16 wherein the sedimentary rock portion comprises a permeability in a range of about 40 millidarcy (md) to about 660 md.
